(19) United States
(12) Patent Application Publication
(10) Pub. No.: US 2026/0346256 A1
(43) Pub. Date: Nov. 5, 2026

(54) AUTOMATED SYSTEMS AND METHODS FOR STABLIZING SAMPLE CONTAINERS DURING MIXING

(71) Applicant: Elemental Scientific, Inc., Omaha, NE (US)

(72) Inventor: Caleb Gilmore, Omaha, NE (US)

(21) Appl. No.: 19/663,537

(22) Filed: Apr. 30, 2026

Related U.S. Application Data
(60) Provisional application No. 63/798,850, filed on May 2, 2025.

(51) Int. Cl. B01L 9/06

(52) U.S. Cl. CPC B01L 9/06

(57) ABSTRACT

Automated systems and methods are described for stabilizing sample containers during a mixing procedure while permitting placement and removal of sample containers and permitting sample probe access to the sample containers. A system embodiment includes, but is not limited to, a support frame defining an axis of rotation; a sample container holder coupled with the support frame via a drive shaft and configured to rotate about the axis of rotation; and a magnetic holder lock configured to transition the sample container holder between an unlocked configuration and a locked configuration dependent upon an angle of rotation of the sample container holder about the axis of rotation.

### CROSS-REFERENCE TO RELATED APPLICATIONS

The present application claims the benefit of 35 U.S.C. §119(e) of U.S. Provisional Application Serial No. 63/798,850, filed May 2, 2025, and titled “AUTOMATED SYSTEMS AND METHODS FOR STABLIZING SAMPLE CONTAINERS DURING MIXING.” U.S. Provisional Application Serial No. 63/798,850 is herein incorporated by reference in its entirety.

### BACKGROUND

In many laboratory settings, it is often necessary to analyze a large number of chemical or biochemical samples at one time. In order to stream-line such processes, the manipulation of samples has been mechanized. Such mechanized sampling is commonly referred to as autosampling and is performed using an automated sampling device or autosampler.

### SUMMARY

Automated systems and methods are described for stabilizing sample containers during a mixing procedure while permitting placement and removal of sample containers and permitting sample probe access to the sample containers. In an aspect, a system embodiment includes, but is not limited to, a support frame defining an axis of rotation; a sample container holder coupled with the support frame via a drive shaft and configured to rotate about the axis of rotation; and a magnetic holder lock configured to transition the sample container holder between an unlocked configuration and a locked configuration dependent upon an angle of rotation of the sample container holder about the axis of rotation.

In an aspect, a method embodiment includes, but is not limited to, introducing a sample container to a sample mixer, the sample mixer including a support frame defining an axis of rotation, a sample container holder coupled with the support frame via a drive shaft and configured to rotate about the axis of rotation, and a magnetic holder lock configured to transition the sample container holder between an unlocked configuration and a locked configuration dependent upon an angle of rotation of the sample container holder about the axis of rotation; rotating the sample container holder over an angle range; locking the sample container within the aperture via the magnetic holder lock during a first portion of the angle range; and unlocking the sample container within the aperture via the magnetic holder lock during a second portion of the angle range.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1 is a schematic illustration of an autosampler system for stabilizing sample containers during a mixing procedure while permitting placement and removal of sample containers and permitting sample probe access to the sample containers, in accordance with an example embodiment of the present disclosure.

FIG. 2A is an isometric view of a sample mixer of the autosampler system of FIG. 1, shown supporting a plurality of sample containers in an upright orientation, in accordance with an example embodiment of the present disclosure.

FIG. 2B is an isometric view of the sample mixer of FIG. 2A, shown supporting the plurality of sample containers in a tilted orientation for mixing contents in the sample container, in accordance with an example embodiment of the present disclosure.

FIG. 3A is a partial isometric view of the sample mixer of FIG. 2A, shown with a slidable layer of a sample container holder in an unlocked configuration to permit introduction and removal of a sample container therefrom, in accordance with an example embodiment of the present disclosure.

FIG. 3B is a partial isometric view of the sample mixer of FIG. 3A, shown with the slidable layer in a locked configuration to prohibit introduction and removal of the sample container therefrom, in accordance with an example embodiment of the present disclosure.

FIG. 4 is a perspective view of the slidable layer of the sample mixer of FIG. 3A, shown with recesses to support a magnet or magnetic material in opposing ends of the slidable layer, in accordance with an example embodiment of the present disclosure.

FIG. 5A is a partial isometric view of the sample mixer of FIG. 2, shown with a support frame of the sample mixer including a plurality of magnets positioned to interact with the magnet coupled with the slidable layer based on a degree of rotation of the sample container holder relative to the support frame, with the sample container holder shown supporting the sample containers in an upright orientation, wherein the magnets are oriented to position the slidable layer in the unlocked configuration when the sample containers are in the upright orientation, in accordance with an example embodiment of the present disclosure.

FIG. 5B is a partial side view of the sample mixer of FIG. 5A, shown with the sample container holder supporting the sample containers in a tilted orientation for mixing, wherein the magnets are oriented to position the slidable layer in the locked configuration when the sample containers are at a specified angle from vertical to prevent the sample containers from falling out of the sample container holder, in accordance with an example embodiment of the present disclosure.

FIG. 6 is a chart illustrating rotational motion of the sample container holder of the sample mixer of FIG. 2A about a rotational axis defined by a drive shaft supported by the support frame, in accordance with an example embodiment of the present disclosure.

FIG. 7 is a partial isometric view of the sample mixer of FIG. 2A, shown with a rack rotator positioned to rotate the sample container holder about a rotational axis defined by a drive shaft supported by the support frame to mix fluids held by the sample containers, in accordance with an example embodiment of the present disclosure.

FIG. 8 is an isometric view of the sample mixer of FIG. 2A, shown positioned on a sample deck adjacent a sample staging rack to receive and hold sample containers that have been mixed by the sample mixer prior to sample analysis, in accordance with an example embodiment of the present disclosure.

### DETAILED DESCRIPTION

### Overview

Often in laboratory settings, large numbers of samples are analyzed. Autosamplers can be used to facilitate the analysis of the sample compositions by removing samples from sample vessels for introduction to sample analysis systems. Uniformity throughout each sample can assist with providing more accurate test results by avoiding inaccuracies associated with concentration gradients within a sample. For biological samples, such as whole blood samples, portions of the sample can settle over time and separate. To achieve uniformity, samples containing immiscible liquids, partially dissolved samples, settling samples, or the like can be stirred or agitated prior to testing. Similarly, solid samples that are placed in solution prior to testing may be heated, stirred, or the like. However, these mixing methods increase the amount of time required to prepare the samples for testing, particularly manual mixing techniques performed by laboratory technicians. If the samples are manually mixed in batch, then later-tested samples may settle over time. If the samples are manually mixed individually before sampling, then laboratory personnel are engaged with timing of each sample to ensure appropriate mixing takes place before each sample is taken.

Moreover, biological samples can be sensitive to vigorous mixing, which can rupture biological cells or otherwise compromise a sample before testing. Some mixing techniques gently rock or invert the sample containers holding samples, however such techniques risk displacing the sample containers (e.g., by having the containers slip out of sample support trays during rocking or inversion), risk incomplete mixing (e.g., by not moving the fluids within the container sufficiently), or require complicated powered systems to lock containers in place that are susceptible to retention failure when portions of the system malfunction or wear down, and so forth. Further, some mixing techniques do not permit a vertical introduction of sample containers into the mixing unit, which prevents introduction of an autosampler-manipulated sample probe into the sample container. For example, such mixing techniques typically arrange the sample containers in an inclined orientation that do not facilitate introduction of a vertically-oriented sample probe, such as those manipulated by an autosampler. Further, some mixing techniques utilize separate mixing stations that are remote from autosampler systems used to draw the sample into a fluid line for analysis or otherwise restrict access to the sample containers by a sample probe of an autosampler during or after mixing, or that require a manual repositioning of the mixed sample vessel by laboratory staff prior to analysis.

Accordingly, the present disclosure is directed, at least in part, to automated systems and methods for stabilizing sample containers (e.g., vials, tubes, bottles, etc.) during a mixing procedure while permitting placement and removal of sample containers and permitting sample probe access to the sample containers. In an aspect, an autosampler system includes a sample mixer including a sample container holder that rotates or oscillates about an axis supported by a support frame. The sample mixer includes a sample container holder having a plurality of layers defining apertures to receive the sample containers to hold the sample containers in the sample mixer, with at least one of the layers slidable relative to the other layer(s) to pinch the containers between edges defining the apertures of different layers.

The support frame and the slidable layer(s) include a sample container holder lock to restrict the motion of the slidable layer(s) based on an orientation of the sample container holder relative to the support frame. In aspects, the sample container holder lock maintains sample containers within the sample container holder when the sample container holder is within a specified angle range relative to the support frame and releases the sample containers within the sample container holder when the sample container holder is within a different angle range relative to the support frame. For example, the sample container holder lock can hold sample containers within the sample container holder when the sample container holder is rotated past horizontal (e.g., in a tilted orientation past 90 degrees from vertical) to prevent the sample containers from falling out and release the sample containers when the sample container holder is substantially upright to permit unloading of the sample containers (e.g., in a vertical orientation). The sample mixer can include a motor to rotate the sample container holder on the support frame about the axis to rotate or oscillate the sample container holder to promote mixing of fluids held in the sample containers.

In aspects, the sample container holder lock includes magnets positioned on one or more of the support frame and the slidable layer(s) to bias the slidable layer(s) towards a locked configuration or towards an unlocked configuration based on a degree of rotation of the sample container holder relative to the support frame. For example, one side of the support frame can include a first magnet at a first position to engage with a magnet or magnetic material on an end of a slidable layer of the sample container holder when the sample container holder is in a first position (e.g., with the sample containers in an upright orientation) and a second magnet at a second position to engage with the magnet or magnetic material on the end of the slidable layer when the sample container holder is in a second position (e.g., with the sample containers in a tilted orientation during mixing). For instance, the first magnet and the second magnet on the support frame can have opposite poles facing towards the sample container holder such that the magnet or magnetic material on the slidable layer is biased in a first lateral direction when adjacent the first magnet (e.g., to unlock the sample container holder) and is biased in a second lateral direction when adjacent the second magnet (e.g., to lock the sample container holder when the sample container holder is rotated). Sizing and placement locations of the magnets can be determined based on the desired interaction range between the magnets or magnetic material and orientation of the sample container holder. Alternatively or additionally, the support frame can include a magnetic material at the first and second positions to interact with a magnet on the end of the slidable layer of the sample container holder.

### Example Implementations

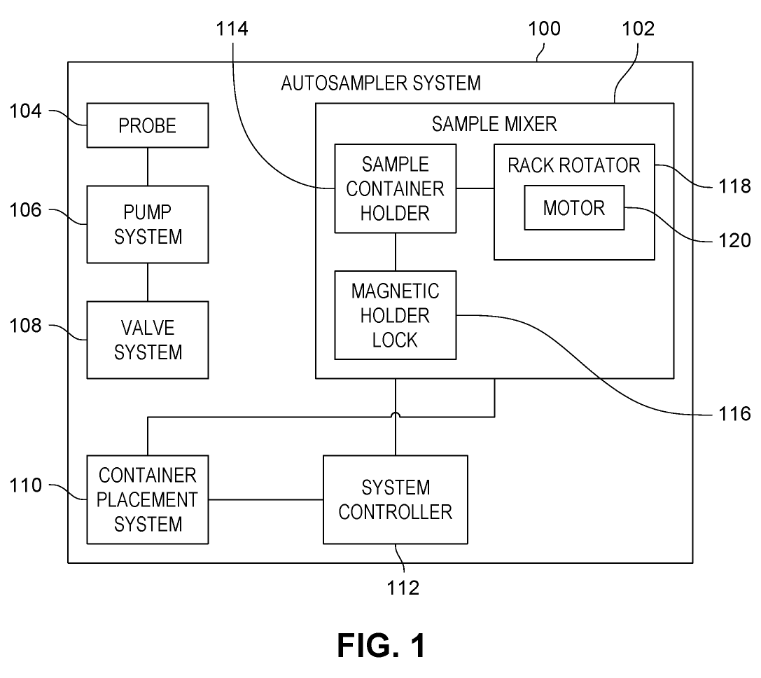

Referring to FIGS. 1 through 8, an autosampler system for stabilizing sample containers during a mixing procedure while permitting placement into and removal of sample containers from a sample mixer and permitting sample probe access to the sample containers (“system 100”) is shown in accordance with example embodiments of the present disclosure. The system 100 is shown in FIG. 1 generally including a sample mixer 102, a probe 104, a pump system 106, a valve system 108, a container placement system 110, and a system controller 112 communicatively coupled with the other system components to facilitate the operations described herein. The sample mixer 102 is configured to rock, rotate, oscillate, or otherwise manipulate the orientation of sample containers (e.g., vials, tubes, bottles, etc.) held by a sample container holder to mix fluids held within the sample containers, such as biological samples for analysis. For example, the sample mixer 102 can hold the sample containers for access by the probe 104 of the system 100 before and after a sample mixing procedure, such as an oscillatory-based mixing procedure described herein. In implementations, the container placement system 110 is configured to automatically load sample containers into the sample mixer 102 and remove sample containers from the sample mixer 102, such as under control by the system controller 112. For example, the container placement system 110 can include a pneumatically-actuated sample gripper to lift sample containers from a source destination (e.g., a source sample rack) for transfer and placement into the sample mixer 102 and can include, for example, the container gripper described in U.S. Application No. 19/051,887, which is incorporated by reference herein.

The sample mixer 102 is shown generally including a sample container holder 114, a magnetic holder lock 116, and a rack rotator 118. As described further herein, the sample container holder 114 can include a rotatable sample rack having a plurality of apertures sized and dimensioned to receive sample vials, sample tubes, sample bottles, or other sample containers for mixing. The rack rotator 118 is shown including a motor 120 to rotate the sample container holder 114 about an axis (e.g., a substantially horizontal axis, or other orientation) which in turn tilts the sample containers, allowing fluids within the sample containers to mix. The magnetic holder lock 116 interacts with the sample container holder 114 to transition the sample container holder 114 between a locked configuration and an unlocked/load configuration dependent on a rotational orientation of the sample container holder 114. For instance, the magnetic holder lock 116 interacts with the sample container holder 114 via magnetic field interaction, such as by including magnets in a frame of the sample mixer 102 to interact with a magnet or magnetic material (e.g., ferromagnetic, diamagnetic, etc.) in the sample container holder 114 based on an orientation of the sample container holder 114, as described further herein.

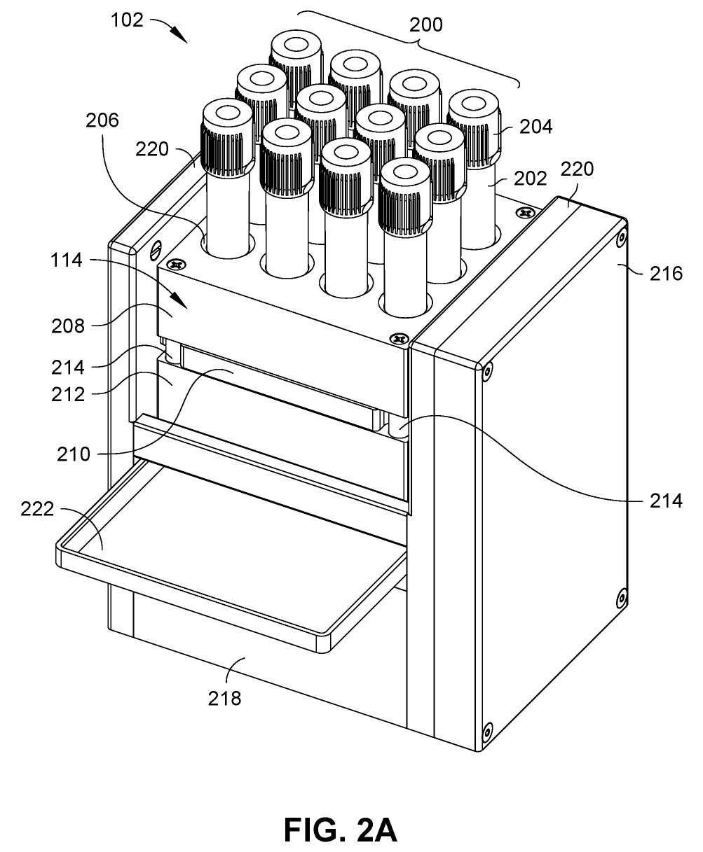

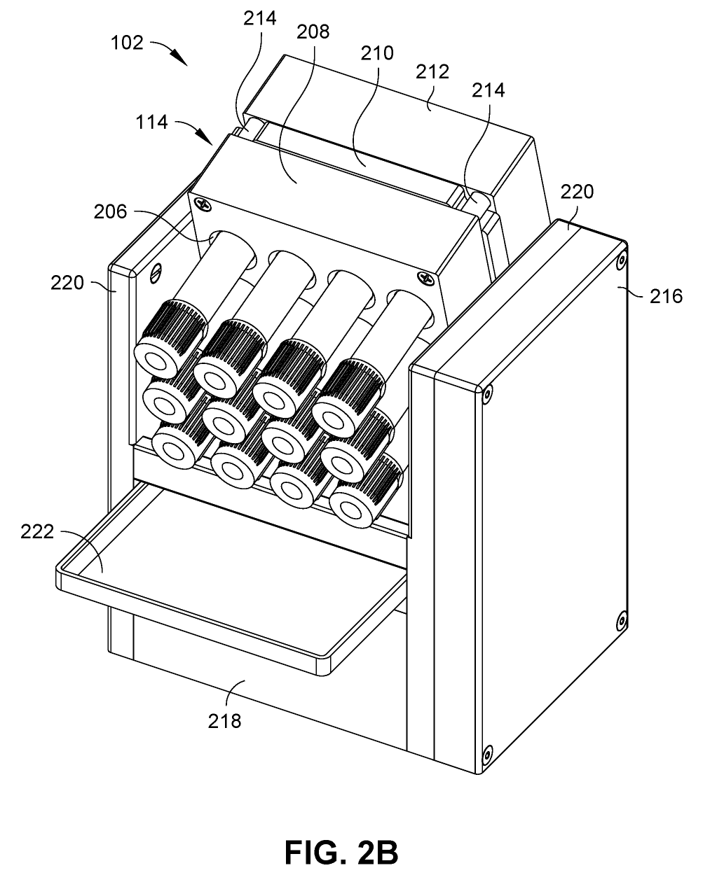

Referring to FIGS. 2A and 2B, the sample mixer 102 is shown supporting a plurality of sample containers 200 for transitioning between an upright orientation (e.g., shown in FIG. 2A) and a tilted orientation (e.g., shown in FIG. 2B) for mixing samples held in the sample containers 200. The sample containers 200 include a sample container base 202 covered by a cap 204 to hold the samples within the sample containers 200 during mixing action by the sample mixer 102, where the cap 204 is generally held fixed to the base 202 via friction fit, threaded engagement, or other mechanism to maintain position on the base 202 even when the sample mixer 102 manipulates the orientation of the sample containers 200 in a tilted orientation past a horizontal orientation (e.g., shown in FIG. 2B). The sample mixer 102 is shown with the sample containers 200 supported within apertures 206 defined by the sample container holder 114. For instance, the sample container holder 114 is shown including a top layer 208, an intermediate layer 210, and a base layer 212 each defining a portion of the apertures 206. For example, the top layer 208 and the intermediate layer 210 define apertures 206 that extend through the respective layers and the base layer 212 defines the apertures 206 through a portion of the base layer 212 to permit the sample containers 200 to rest on the base layer 212 when inserted into the apertures 206 (e.g., in the upright orientation). In implementations the top layer 208 and the base layer 212 are fixed relative to other, such as through support posts 214 extending between and into the respective layers. While the sample container holder 114 is shown with twelve apertures 206 to hold up to twelve sample container 200 simultaneously, the present disclosure is not limited to such configuration and can include any number of apertures 206 within the sample container holder 114, such as dependent on the type or volume of the sample containers 200 utilized by the system 100. For example, the sample container holder 114 can include fewer than twelve apertures 206 or more than twelve apertures 206 without departing from the scope of the present disclosure.

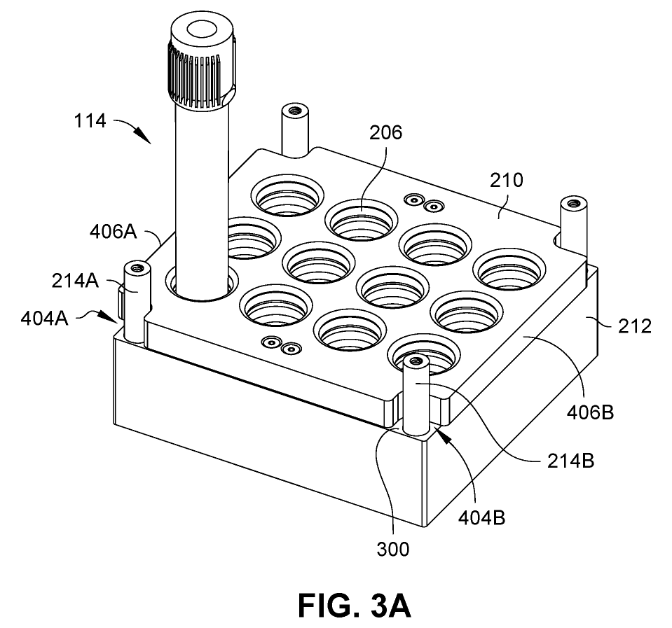

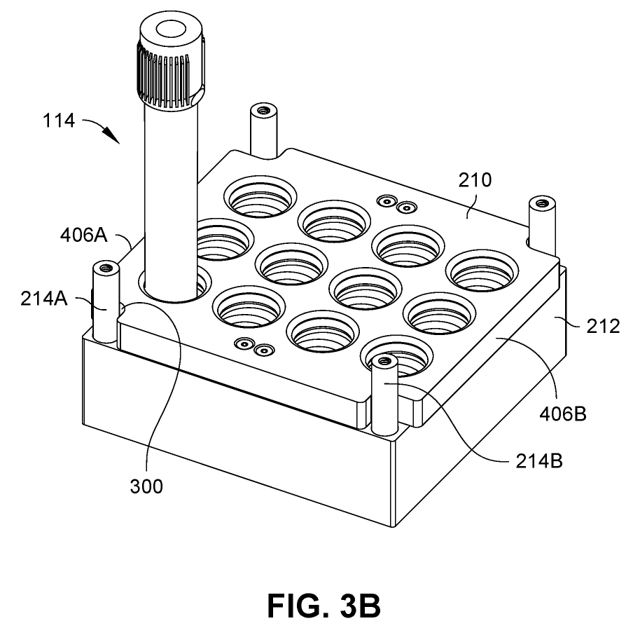

At least one of the top layer 208, the intermediate layer 210, and the base layer 212 is configured to laterally move relative to the other layers to transition between an aligned configuration and a partial misaligned configuration of the apertures 206. In the aligned configuration, the apertures 206 are vertically aligned to permit the sample containers 200 to pass or otherwise fit within the apertures 206 to seat the sample containers 200 within the sample container holder 114. In the partial misaligned configuration, the apertures 206 are vertically offset, which causes sample containers 200 to be pinched between edges defining the apertures 206 of the different layers. For example, referring to FIGS. 3A and 3B, the intermediate layer 210 of the sample container holder 114 is permitted to slide relative to the top layer 208 and the base layer 212 to translate between an aligned configuration (e.g., an unlocked configuration of the magnetic holder lock 116), which aligns the apertures 206 of the layers (shown in FIG. 3A, with the top layer 208 removed), and a partial misaligned configuration (e.g., a locked configuration of the magnetic holder lock 116), which partially misaligns the apertures 206 of the intermediate layer 210 with respect to the aligned apertures 206 of the top layer 208 and the base layer 212 (shown in FIG. 3B, with the top layer 208 removed).

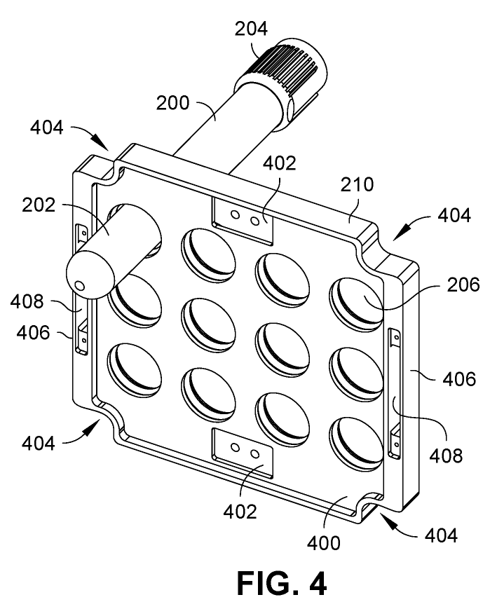

In implementations, the intermediate layer 210 laterally translates with respect to the top layer 208 and the base layer 212 by sliding on the base layer 212. For example, referring to FIG. 4, a bottom surface 400 of the intermediate layer 210 is shown defining a carriage recess 402 to receive a carriage (e.g., ball bearing carriage) to slide on a rail supported by the base layer 212 (e.g., on a top surface of the base layer 212) to permit the intermediate layer 210 to slide back and forth between the aligned configuration and the partial misaligned configuration. For example, the intermediate layer 210 is shown having cut out portions 404 on opposing ends 406 of the intermediate layer 210 positioned to receive and abut the support posts 214 extending between the top layer 208 and the base layer 212 as the intermediate layer 210 translates. In implementations, the cut out portions 404 are sized and dimensioned to permit contact between the intermediate layer 210 and the support posts 214 on one end 406 of the intermediate layer 210 at a time. For example, the intermediate layer 210 is shown in the aligned configuration in FIG. 3A with the cutout portion 404A contacting the support post 214A on one end 406A of the intermediate layer 210 and with the cutout portion 404B spaced apart from the support post 214B on the opposing end 406B of the intermediate layer 210 (e.g., leaving a gap 300 between the intermediate layer 210 and the support post 214B). In FIG. 3B, the intermediate layer 210 is shown having translated into the partial misaligned configuration with the cutout portion 404B contacting the support post 214B on one end 406B of the intermediate layer 210 and with the cutout portion 404A spaced apart from the support post 214A on the opposing end 406A of the intermediate layer 210 (e.g., leaving a gap 300 between the intermediate layer 210 and the support post 214A). As described further herein, the magnetic holder lock 116 utilizes magnetic fields to slide the intermediate layer 210.

In implementations, one or more of the layers of the sample container holder 114 includes a seal (e.g., an o-ring) about the apertures 206 such that the seal contacts and grips the sample container base 202 when the sample container holder 114 is in the partial misaligned/locked configuration to prevent the sample container 200 from slipping past, such as when the sample container 200 is in a tilted orientation (e.g., past 90 degrees from vertical).

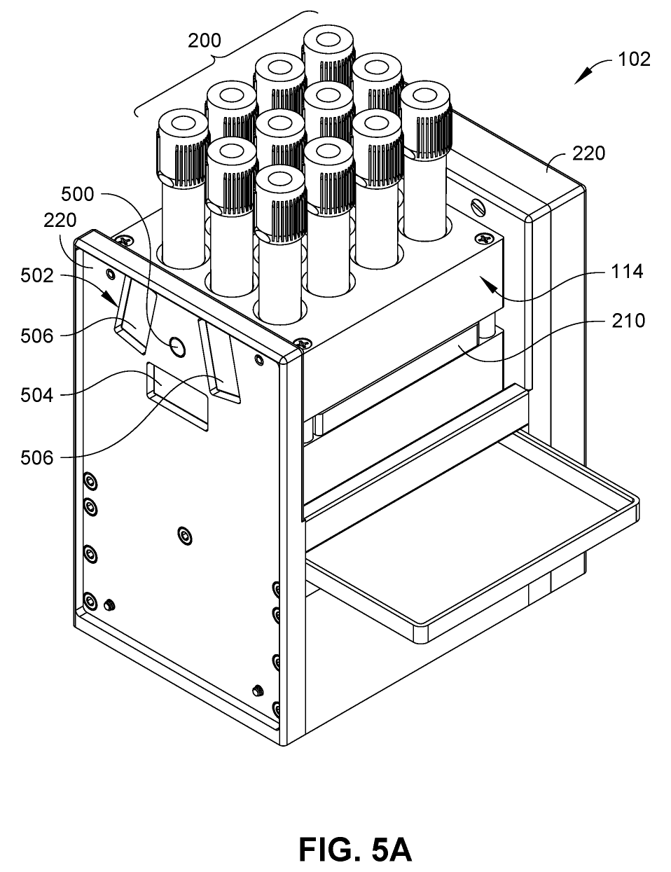

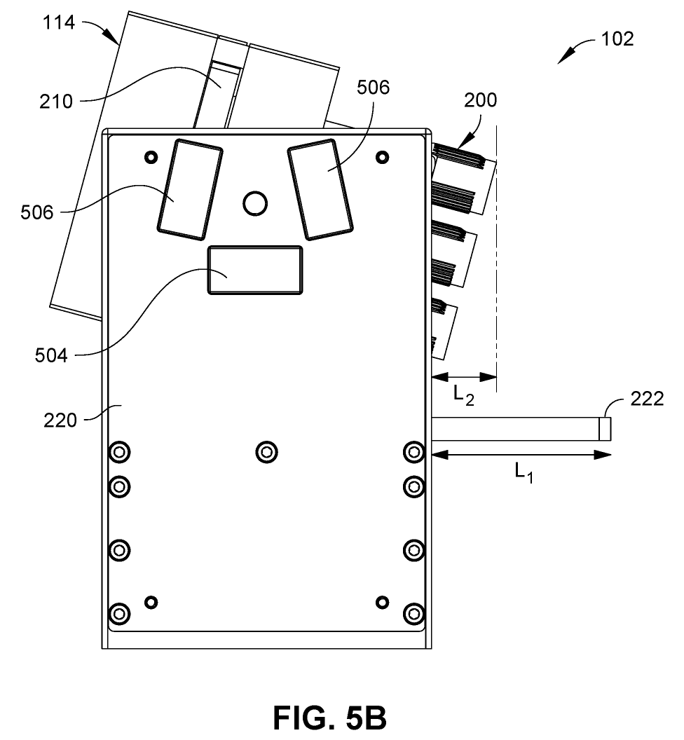

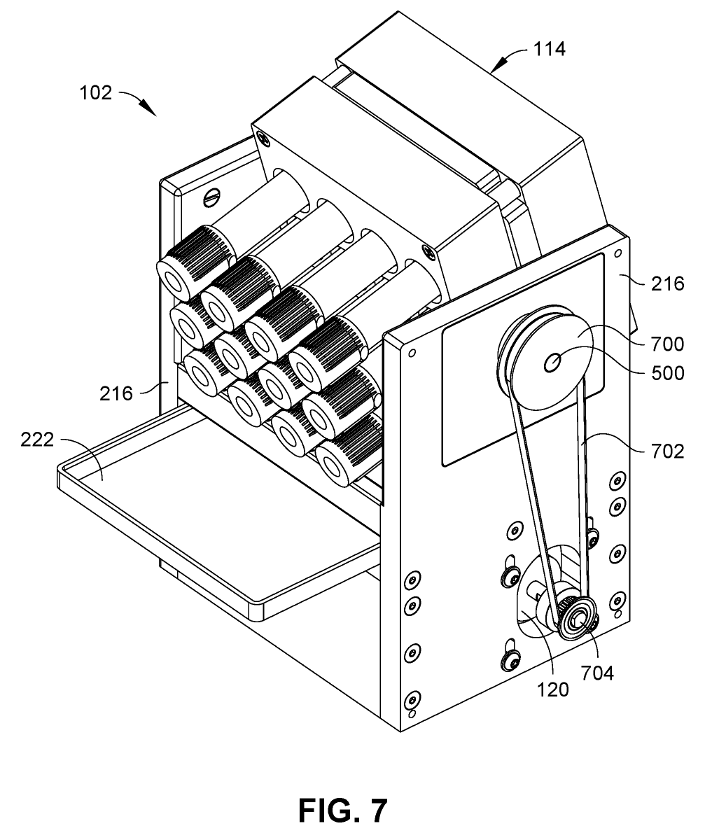

Referring back to FIGS. 2A and 2B, the sample mixer 102 is shown including a support frame 216 that suspends the sample container holder 114 above a frame base 218 and between opposing frame sides 220 to permit rotation of the sample container holder 114 about a rotational axis with respect to the frame base 218. For instance, one or more of the frame sides 220 can support a drive shaft driven by the motor 120 to rotate the sample container holder 114. For example, referring to FIGS. 5A and 5B, the frame side 220 includes a drive shaft 500 that extends at least partially into the sample container holder 114 (e.g., into the top layer 208, supported by a bearing). In implementations, each of the opposing frame sides 220 includes a drive shaft 500 to support the sample container holder 114 at two rotational points. Referring to FIG. 7, the frame side 220 can support a pulley 700 coupled with the drive shaft 500 and driven by a belt 702 via rotation of an output shaft 704 the motor 120 of the rack rotator 118. For example, the frame base 218 can house the motor 120 to rotate the sample container holder 114 about the rotational axis defined by the drive shaft 500.

The support frame 216 includes components of the magnetic holder lock 116 to interact with components of the sample container holder 114 to transition the sample container holder 114 between the locked and unlocked configurations based on an orientation of the sample container holder 114 with respect to the support frame 216. For example, referring back to FIGS. 5A and 5B, the support frame 216 is shown including magnets 502 supported by the frame side 220 to magnetically interact with the sample container holder 114 to transition the sample container holder 114 between the locked and unlocked configurations. The magnets 502 include a first magnet 504 positioned beneath the axis of rotation defined by the drive shaft 500 and beneath two upper magnets 506. For instance, the first magnet 504 is arranged in a substantially horizontal orientation with the upper magnets 506 angled inwardly from a vertical orientation. The magnets 502 are positioned on the frame side 220 to magnetically interact with the intermediate layer 210, with the orientation of the sample container holder 114 bringing the intermediate layer 210 into and out of proximity with individual magnets 502. For example, referring to FIG. 4, the intermediate layer 210 is shown including recesses 408 on opposing ends 406 to house a magnet to interact with the magnets 502 as the motor 120 rotates the sample container holder 114 about the rotational axis (e.g., defined by the drive shaft 500). Alternatively or additionally, the recesses 408 can house a magnetic material (e.g., ferromagnetic, diamagnetic, etc.) to interact with the magnetic field from the magnets 502, dependent on a particular direction of attraction or repulsion from the opposing frame sides 220.

In implementations, the first magnet 504 is positioned to interface with the intermediate layer 210 (e.g., the intermediate layer 210 is adjacent the first magnet 504) when the sample container holder 114 is in the upright orientation (e.g., as shown in FIGS. 2A and 5A). For instance, the first magnet 504 can be oriented to repel the intermediate layer 210, such as by having a magnetic pole that is the opposite of a magnetic pole of a magnet in the intermediate layer 210 (e.g., housed in the recess 408). Such repulsion can cause the intermediate layer 210 to laterally slide with respect to the top layer 208 and the base layer 212 to cause the apertures 206 to be in the aligned configuration (e.g., with the sample container holder 114 in the unlocked configuration) to permit the sample containers 200 to be loaded into and unloaded from the sample container holder 114 while in the upright orientation. Alternatively, the first magnet 504 can be oriented to attract the intermediate layer 210, depending on, for example, the configuration of the intermediate layer 210 to align the apertures 206. By having the sample container holder 114 in the unlocked configuration while in the upright orientation, the system 100 facilitates automated loading and unloading of sample containers 200 in the sample container holder 114 by the container placement system 110 from a vertical pick and place orientation. In implementations, the opposing frame side 220 can include a second set of magnets 502 in the same configuration as the first set of magnets 502 but having reverse polarization with respect to the first set of magnets 502 on the first frame side 220 to attract the intermediate layer 210 to the opposing frame side 220 while the sample container holder 114 is in the upright orientation.

The upper magnets 506 are positioned to interface with the intermediate layer 210 following rotation of the sample container holder 114 away from the upright orientation to transition the sample container holder 114 to the locked configuration to hold the sample containers 200 in place while the sample container holder 114 is rotated by the motor 120. For instance, the upper magnets 506 can be oriented to attract the intermediate layer 210, such as by having a magnetic pole that is the opposite of a magnetic pole of a magnet in the intermediate layer 210 (e.g., housed in the recess 408). For example, the upper magnets 506 are arranged to have a magnetic pole that is the opposite of a magnetic pole of the first magnet 504 facing towards the intermediate layer 210 to have an opposite interaction with the intermediate layer 210 (e.g., the first magnet 504 repels while the upper magnets 506 attract, or vice versa).

Such attraction by the upper magnets 506 can cause the intermediate layer 210 to laterally slide with respect to the top layer 208 and the base layer 212 to cause the apertures 206 to be in the partial misaligned configuration (e.g., with the sample container holder 114 in the locked configuration) to prevent the sample containers 200 from slipping out of the apertures 206 in the sample container holder 114 while the sample container holder 114 is rotated, particularly past a horizontal orientation (e.g., more than 90 degrees from the vertical upright orientation). In implementations, the opposing frame side 220 can include a second set of magnets 502 in the same configuration as the first set of magnets 502 but having reverse polarization with respect to the first set of magnets 502 on the first frame side 220 to repel the intermediate layer 210 from the opposing frame side 220 while the sample container holder 114 is rotated past the upright orientation. Alternatively, the opposing frame sides 220 can include magnets solely to attract, such as by having one frame side 220 with the first magnet 504 and with the opposing frame side 220 having the upper magnet 506 to slide the intermediate layer 210.

The size, positioning, and orientation of the magnets 502 on a given frame side 220 influences the amount of interaction with the intermediate layer 210, where the size, positioning, and orientation of the magnets 502 can be designed to provide a desired range of rotations in each of the locked and unlocked configurations. In implementations, the first magnet 502 is substantially horizontally arranged to interact with the intermediate layer 210 when the sample container holder 114 is in the upright orientation. As the sample container holder 114 is rotated past the vertical orientation, the first magnet 504 interacts with the intermediate layer 210 for a limited duration until the sample container holder 114 is rotated beyond the effective magnetic field between the first magnet 504 and the intermediate layer 210. Beyond the effective magnetic field between the first magnet 504 and the intermediate layer 210, the sample container holder 114 could be in the unlocked state or in a neutral state between the unlocked and locked states, such as if neither the first magnet 504 nor the upper magnet 506 has a substantial magnetic interaction with the intermediate layer 112.

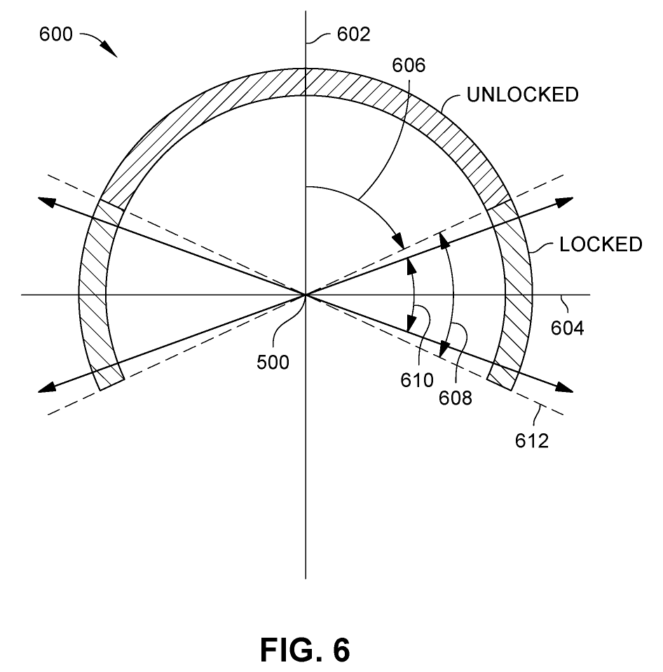

For example, referring to FIG. 6, a chart 600 is shown providing a diagrammatic illustration of rotation of the sample container holder 114 about a horizontal axis defined by the drive shaft 500 (e.g., extending into and out of the page) as the sample container holder 114 is rotated from a vertical axis 602 (e.g., in the upright orientation) towards or away from a horizontal axis 604. The magnetic holder lock 116 maintains the sample container holder 114 in the unlocked configuration from the vertical axis 602 as the sample container holder 114 is rotated towards a locked configuration, shown as 606, at which point the upper magnet 506 interacts with the intermediate layer 210 to transition the sample container holder 114 from the unlocked configuration (or a neutral configuration) to the locked configuration. The size and orientation of the upper magnet 506 permits the sample container holder 114 to be moved through a range of rotational angles (shown as 608) while maintaining the sample container holder 114 in the locked configuration.

In implementations, the system 100 provides a mixing operation by rotating the sample container holder 114 about the rotational axis for a range of angles across the horizontal axis 604 (shown as 610). For instance, the range of angles 610 is less than the total range of angles 608 that the sample container holder 114 is in the locked configuration to maintain the mixing operation within the locked configuration. For example, implementations, the range of angles 610 is a 40 degree range, with approximately 20 degrees above and below the horizontal axis 604 to provide mixing of sample within the sample container 200. However, it will be appreciated that the sample container holder 114 can be rotated according to any desired rotational range, speed, frequency, or the like. In implementations, the maximum range of rotation from the vertical axis 602 (e.g., shown as 612) can be limited by interaction between a portion of the sample container 200 and the frame base 218, such as by rotating the cap 204 into contact with the frame base 218, preventing further rotation in that direction.

In implementations, the sample mixer 102 facilitates sample spillage prevention by capturing fluids that could spill from sample containers 200 (e.g., if the cap 204 is not securely seated on the base 202), particularly when the sample container holder 114 is rotated past the horizontal axis 604 (e.g., rotated more than 90 degrees from the vertical axis 602). For example, the sample mixer 102 is shown including a spill tray 222 extending from frame base 218. The spill tray 222 is positioned beneath the sample container holder 114 to capture and collect any fluids that might leak or otherwise leave the sample containers 200, such as if a cap 204 were to fall off the sample container 200. In implementations, the spill tray 222 extends from the frame base 218 for a length (shown as L₁ in FIG. 5B) that exceeds a maximum length of extension of the sample containers 200 from the frame base 218 (shown as L₂ in FIG. 5B). The spill tray 222 can be removably coupled with the support frame 216, such as to remove the spill tray 222 for fluid cleanup if fluid contacts the spill tray 222.

While the support frame 216 is shown with two upper magnets 506 coupled with a single frame side 220 to facilitate engagement of the upper magnets 506 with the intermediate layer 210 during rotation of the sample container holder 114 about the rotational axis from both directions (shown as 614, 616) from the vertical axis 602, the system 100 is not limited to such configuration and can include a single upper magnet 506 to drive the sample container holder 114 in a single direction from the vertical axis 602 without departing from the scope of the present disclosure.

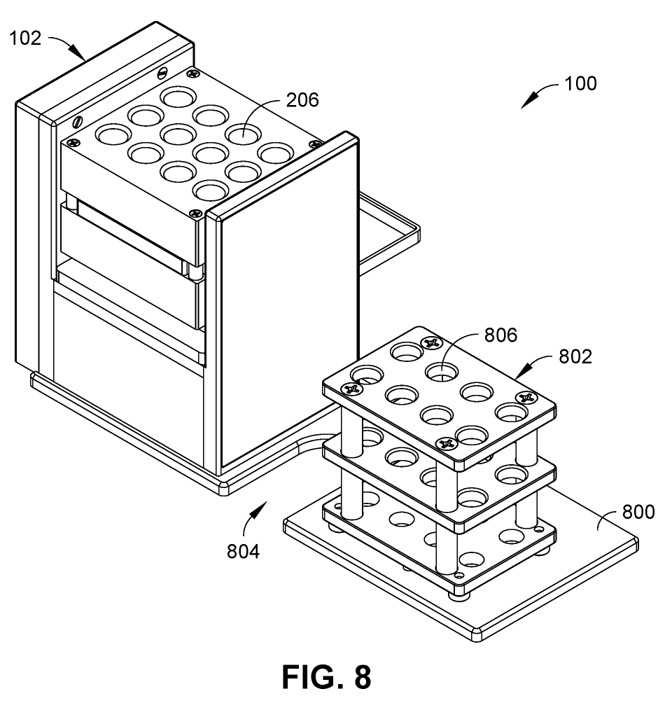

Referring to FIG. 8, the system 100 is shown with the sample mixer 102 positioned on a sample deck 800 adjacent a sample staging rack 802. The sample deck 800 includes a cut out 804 to facilitate introduction of a portion of the container placement system 110 (e.g., a support arm for pivoting a container gripper above each of the sample mixer 102 and the sample staging rack 802) to introduce and remove sample containers from each of the sample mixer 102 and the sample staging rack 802. During an example mixing procedure, the container placement system 110 introduces sample containers 200 containing unmixed samples into the apertures 206 of the sample container holder 114, for example, filling each of the apertures 206 with sample containers 200, unless fewer sample containers 200 are available. The sample mixer 102 is then activated to begin sample mixing, such as by having the system controller 112 activate the motor 120 to rotate the sample container holder 114 about the rotational axis (e.g., defined by the drive shaft 500) according to the predetermined rotational mixing. For example, the sample mixer 102 can move the sample container holder 114 from an initial loading position of zero degrees from the vertical axis 602, transition the sample container holder to a maximum rotated position of 110 degrees from the vertical axis 602, and then oscillate the sample container holder 114 from about 70 degrees from the vertical axis 602 to about 110 degrees from the vertical axis 602 to mix sample fluids held therein. However, the system 100 is not limited to such oscillation ranges and can include any angles from vertical suitable to induce fluidic motion within the sample containers 200 to mix the sample fluids. In implementations, the oscillations are controlled by the motor 120 to oscillate between about 10 to about 30 repetitions per minute, however the system 100 is not limited to such oscillation rates and can include any oscillation rate suitable to provide mixing of the sample fluids (e.g., without rupturing biological cells held therein). Similarly, the system 100 controller can maintain the operation of the sample mixer 102 for any desired mixing duration. In implementations, the system 100 can include a pre-set or user-selected system operating variables, such as maximum angle of rotation, oscillation rate, oscillation angle, hold time at different positions, and the like.

Upon a predetermined mixing time for a given sample container 200 (e.g., from about 2 minutes to about 30 minutes), the motor 120 brings the sample container holder 114 back to the initial upright orientation to permit removal of the sample container, now containing mixed sample, by the container placement system 110 for transfer to an empty position at the sample staging rack 802 (e.g., within an aperture 806). The system 100 permits the mixed sample to rest at the sample staging rack 802 for a duration sufficient to permit mixed sample held in the cap 204 or upper walls of the sample container base 202 to flow back to the bottom sample container base 202 or into contact with the remainder of the mixed sample, but not so long as to permit the mixed sample to separate. The sample container 200 can then be transferred from the sample staging rack 802 to a site for sample analysis of the mixed sample, such as to an uncapper to remove the cap 204, or the sample probe 104 can be introduced into the sample container 200 at the sample staging rack 802 or at the sample container holder 114 as desired. A replacement sample container 200 can be introduced into the sample container holder 114 in the aperture 206 previously occupied by the removed sample container 200 to permit a continuous mixing operation for a plurality of sample containers 200. In implementations, the system 110 tracks the length of time that a particular sample container 200 has been processed by the system 100, such as a length of time of oscillation by the sample mixer 102 for each sample container 200.

Electromechanical devices (e.g., electrical motors, servos, actuators, or the like) may be coupled with or embedded within the components of the system 100 to facilitate automated operation via control logic embedded within or externally driving the system 100. The electromechanical devices can be configured to cause movement of devices and fluids according to various procedures, such as the procedures described herein. The system 100 may include or be controlled by a computing system having a processor or other controller configured to execute computer readable program instructions (i.e., the control logic) from a non-transitory carrier medium (e.g., storage medium such as a flash drive, hard disk drive, solid-state disk drive, SD card, optical disk, or the like). The computing system can be connected to various components of the system, either by direct connection, or through one or more network connections (e.g., local area networking (LAN), wireless area networking (WAN or WLAN), one or more hub connections (e.g., USB hubs), and so forth). For example, the computing system can be communicatively coupled to the system controller 112, the motor 120, the container placement system 110, and the sample probe 104, fluid handling systems (e.g., valves, pumps, etc.), other components described herein, components directing control thereof, or combinations thereof. The program instructions, when executed by the processor or other controller, can cause the computing system to control the system (e.g., control positioning of the sample mixer and the sample probe, control movement of fluids via the sample probe, control positions of the valve system, etc.) according to one or more modes of operation, as described herein.

It should be recognized that the various functions, control operations, processing blocks, or steps described throughout the present disclosure may be carried out by any combination of hardware, software, or firmware. In some embodiments, various steps or functions are carried out by one or more of the following: electronic circuitry, logic gates, multiplexers, a programmable logic device, an application-specific integrated circuit (ASIC), a controller/microcontroller, or a computing system. A computing system may include, but is not limited to, a personal computing system, a mobile computing device, mainframe computing system, workstation, image computer, parallel processor, or any other device known in the art. In general, the term “computing system” is broadly defined to encompass any device having one or more processors or other controllers, which execute instructions from a carrier medium.

Program instructions implementing functions, control operations, processing blocks, or steps, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

### Conclusion

It will be appreciated that features described herein with respect to embodiments or implementations can be combined with any other feature or features described with respect to the same or alternative embodiments, unless context otherwise dictates, without departing from the scope of the present disclosure.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A sample mixer for an autosampler system, comprising:
a support frame defining an axis of rotation;
a sample container holder coupled with the support frame via a drive shaft and configured to rotate about the axis of rotation; and
a magnetic holder lock configured to transition the sample container holder between an unlocked configuration and a locked configuration dependent upon an angle of rotation of the sample container holder about the axis of rotation.

2. The sample mixer of claim 1, wherein the sample container holder includes a plurality of layers each of which defines at least one aperture into which a sample container can be inserted.

3. The sample mixer of claim 2, wherein the apertures of the plurality of layers are in an aligned configuration when the sample container holder is in the unlocked configuration to permit entry and removal of the sample container.

4. The sample mixer of claim 2, wherein the apertures of the plurality of layers are in a partial misaligned configuration when the sample container holder is in the locked configuration to prevent removal of the sample container from the sample container holder.

5. The sample mixer of claim 2, wherein the plurality of layers includes a top layer, an intermediate layer, and a base layer, the top layer and the base layer are stationary with respect to each other, and the intermediate layer is laterally slidable between the top layer and the base layer.

6. The sample mixer of claim 5, wherein the sample container holder further includes support posts extending between the top layer and the base layer to fix the top layer with respect to the base layer.

7. The sample mixer of claim 5, wherein support frame includes opposing frame sides supporting the sample container holder therebetween, and wherein at least one of the opposing frame sides includes a plurality of magnets configured to magnetically interact with the intermediate layer dependent upon the angle of rotation of the sample container holder about the axis of rotation.

8. The sample mixer of claim 7, wherein the plurality of magnets includes a first magnet having a first polarity facing the opposing frame side and includes a second magnet having a second polarity facing the opposing frame side, wherein the first polarity and the second polarity are opposite polarities.

9. The sample mixer of claim 8, wherein the intermediate layer includes a third magnet.

10. The sample mixer of claim 8, wherein each of the opposing frame sides includes a plurality of opposing magnets, wherein each of the opposing magnets are opposite polarity.

11. A method of agitating a sample, the method comprising the steps of:
introducing a sample container to a sample mixer, the sample mixer including
a support frame defining an axis of rotation,
a sample container holder coupled with the support frame via a drive shaft and configured to rotate about the axis of rotation, and
a magnetic holder lock configured to transition the sample container holder between an unlocked configuration and a locked configuration dependent upon an angle of rotation of the sample container holder about the axis of rotation;
rotating the sample container holder over an angle range;
locking the sample container within the aperture via the magnetic holder lock during a first portion of the angle range; and
unlocking the sample container within the aperture via the magnetic holder lock during a second portion of the angle range.

12. The method of claim 11, wherein the sample container holder includes a plurality of layers each of which defines at least one aperture into which a sample container can be inserted.

13. The method of claim 12, wherein the apertures of the plurality of layers are in an aligned configuration when the sample container holder is in the unlocked configuration to permit entry and removal of the sample container.

14. The method of claim 12, wherein the apertures of the plurality of layers are in a partial misaligned configuration when the sample container holder is in the locked configuration to prevent removal of the sample container from the sample container holder.

15. The method of claim 12, wherein the plurality of layers includes a top layer, an intermediate layer, and a base layer, the top layer and the base layer are stationary with respect to each other, and the intermediate layer is laterally slidable between the top layer and the base layer.

16. The method of claim 15, wherein the sample container holder further includes support posts extending between the top layer and the base layer to fix the top layer with respect to the base layer.

17. The method of claim 15, wherein support frame includes opposing frame sides supporting the sample container holder therebetween, and wherein at least one of the opposing frame sides includes a plurality of magnets configured to magnetically interact with the intermediate layer dependent upon the angle of rotation of the sample container holder about the axis of rotation.

18. The method of claim 17, wherein the plurality of magnets includes a first magnet having a first polarity facing the opposing frame side and includes a second magnet having a second polarity facing the opposing frame side, wherein the first polarity and the second polarity are opposite polarities.

19. The method of claim 18, wherein the intermediate layer includes a third magnet.

20. The method of claim 18, wherein each of the opposing frame sides includes a plurality of opposing magnets, wherein each of the opposing magnets are opposite polarity.
